(19) United States
(12) Patent Application Publication
(10) Pub. No.: US 2011/0036776 A1
(43) Pub. Date: Feb. 17, 2011

(54) PROCESSING METHOD OF LIQUID

(75) Inventors: Hirohisa Fujita, Saitama-shi (JP); Masashi Miyagawa, Yokohama-shi (JP); Takeshi Takada, Yokohama-shi (JP); Kouji Inoue, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/853,550

(22) Filed: Aug. 10, 2010

(30) Foreign Application Priority Data
Aug. 13, 2009 (JP) 2009-187699

(51) Int. Cl. B01D 15/04; B01J 10/00

(52) U.S. Cl. 210/668

(57) ABSTRACT

A processing method of liquid includes: decomposing a resin in liquid by allowing ozone gas to contact the liquid containing a water-soluble carbonyl compound and the resin; and removing organic acid generated by decomposing the resin in the decomposing step from the liquid by performing on the liquid after being subjected to the decomposing step an ion exchange process using an ion exchange resin. The liquid to be subjected to the ion exchange process contains water.

### BACKGROUND OF THE INVENTION

1. Field of the Invention

The present invention relates to a processing method of liquid, which includes removing a resin component from liquid used for peeling an organic resin component of a substrate surface.

2. Description of the Related Art

In the manufacturing of nozzles of an ink jet head and liquid crystal panels, photolithography is used. In such fields, when etching is performed on metal and insulators formed on a substrate, the surface thereof or a specific member is protected by a resist consisting of an organic resin, and the resist is removed after the etching is terminated. For the removal of the resist, there is a method of performing an asking process using oxygen plasma. In this method, when a metal film and an organic film with insufficient oxidation resistance are exposed on the substrate, the metal film and the organic film are oxidized, which is not desirable. There, the resist used for performing etching on the metal film and the organic film is removed using an organic solvent as a peeling liquid. However, as the peeling liquid is repeatedly used, a force dissolving the resist is reduced. Accordingly, the peeling liquid that has been used for a certain time has to be replaced with a new solvent.

In terms of global environmental protection, the establishment of a recycling process technique of recycling the peeling liquid rather than disposing of the peeling liquid is desired. In recent years, a recycling process technique for a peeling liquid using ozone gas which is safe as the ozone gas returns to oxygen when decomposed and thus has a low environmental load has been developed.

For example, Japanese Patent Application Laid-Open No. 2004-241602 discloses a method of processing a peeling liquid for a resist on a substrate surface using ozone, performing an ion exchange process thereon, and then removing organic acid that is generated by the ozone process.

However, there may be a case where the organic acid does not sufficiently dissociate in an organic solvent and thus cannot be sufficiently removed by the ion exchange process, so that there is a concern that a substrate-shaped metal film will be dissolved by the remaining organic acid when the peeling liquid is reused.

### SUMMARY OF THE INVENTION

In order to solve the above-mentioned problem, the invention provides a method of processing a liquid by removing a resin component from the liquid used as a peeling liquid so that the liquid rarely affects films such as a metal film on a substrate when the liquid is reused as the peeling liquid and thus can be stably used as the peeling liquid.

According to an aspect of the invention, a processing method of liquid includes: decomposing a resin in liquid by allowing ozone gas to contact the liquid containing a water-soluble carbonyl compound and the resin; and removing organic acid generated by decomposing the resin in the decomposing from the liquid by performing on the liquid after being subjected to the decomposing an ion exchange process using ion exchange resin, wherein the liquid to which the ion exchange process is performed contains water.

According to the aspect of the invention, it is possible to stably reuse the peeling liquid for removing the resin components.

Further features of the present invention will become apparent from the following description of exemplary embodiments with reference to the attached drawings.

### BRIEF DESCRIPTION OF THE DRAWINGS

FIG. 1 is a schematic view of a substrate processing apparatus including a recycling device of a peeling liquid according to an embodiment, when a recycling process of the peeling liquid according to the invention is performed.

FIG. 2 is a schematic view of a substrate processing apparatus including a recycling device of a peeling liquid, for performing a recycling process of the peeling liquid according to a first comparative example.

FIG. 3 is a flowchart of a manufacturing process of an ink jet printer substrate using a recycling method of the peeling liquid according to the invention.

### DESCRIPTION OF THE EMBODIMENTS

Preferred embodiments of the present invention will now be described in detail in accordance with the accompanying drawings.

The inventors invented a recycling method of a peeling liquid, capable of peeling an organic resin component on a substrate surface using a specific peeling liquid, recycling the peeling liquid in which the organic resin component is dissolved using ozone gas, and processing the liquid subjected to the recycling process using an ion exchange resin, thereby removing organic acid and impurities that may damage the substrate and films on the substrate. Particularly, the peeling liquid that peels the organic resin component is subjected to the recycling process with ozone gas so as to decompose the organic resin component in the peeling liquid into low-molecular components, and the ion exchange process is performed on the processing liquid containing the decomposed low-molecular organic acid or impurities. Particularly, the liquid processed during the ion exchange contains water. Accordingly, it is possible to decrease the concentrations of the organic acid or the impurities in the processing liquid, thereby obtaining a recycling peeling liquid so as not to corrode metal such as aluminum on the substrate. Particularly, in the method according to the invention, a composition of the peeling liquid and a combination of the ion exchange resin in the ion exchange process can be optimized.

### <Recycling Method of Peeling Liquid>

### (Peeling Liquid)

In this embodiment, the peeling liquid for peeling the organic resin component on the substrate surface contains a water-soluble carbonyl compound and water for dissolving and peeling the organic resin component.

In addition, as described later, the peeling liquid is subjected to the recycling process by ozone gas after peeling the organic resin component, so that those that are ozone-resistant and are not reactive to ozone are used as the peeling liquid. To break unsaturated bonds such as double bonds, to oxidize aromatic compounds having electron donor groups, or to exhibit high responsiveness to sulfides or molecules having nucleophilic atoms such as amines, ozone decomposes such materials. In addition, in ozone reactions at high pH, significant ozone autolysis occurs. However, in this process, highly active OH radicals may be generated, which are the main components involved in oxidation reactions. Therefore, there may be a case where strong oxidizing power for decomposing those that cannot be decomposed during typical oxidations is exhibited, which results in generation of neutralization heat and smoke emission.

In terms of handling during the ozone recycling process and suppression of damage of a polyetheramide layer on the substrate, as a water-soluble carbonyl compound, there are water-soluble carbonyl compounds having ozone resistance, for example, γ-butyrolactone (Formula (3)), ethylene carbonate, ethylene acetate, and glycerol acetate. Those can be used singly or in combinations of two or more kinds thereof. According to the invention, since such water-soluble carbonyl compounds are dissolved in water so as to be used, carbonyl compounds such as ethylene carbonate which is solid at room temperature achieve enhanced handleability. Moreover, the recycling process using ozone gas and the ion exchange process by the ion exchange resin can be smoothly performed. Among the materials, as the water-soluble carbonyl compound, γ-butyrolactone (Formula (3)) which is a liquid at room temperature can be used as the compound is easily mixed with water.

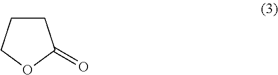

The peeling liquid according to the invention may contain a water-soluble organic solvent as well as the water-soluble carbonyl compound and water as long as the peeling liquid does not adversely influence the effects of the invention.

As the reviewing result of the invention, it was found that in the case where the water-soluble carbonyl compound is γ-butyrolactone, when an amount of water contained in the peeling liquid is equal to or greater than 10 mass % and equal to or smaller than 32 mass %, the peeling performance of the organic resin component is recovered, and particularly, the peeling liquid from which organic acid or impurities that damage the substrate are removed is properly recycled. The amount of water contained in the peeling liquid can be equal to or greater than 15 mass % and equal to or smaller than 25 mass %.

Types of the organic resin component to be peeled from the substrate surface are not particularly limited as long as they are dissolvable in the peeling liquid and can be decomposed into low molecules by the oxidation or decomposition reactions by ozone, and unsaturated hydrocarbons including a double bond or a triple bond as the structure are desired. For example, novolac-based resins can be used.

Methods of peeling the organic resin component from the substrate surface by the peeling liquid are not particularly limited, and for example, immersion in a tank or spraying atomization may be used.

Moreover, through the specification, the “peeling liquid” is a liquid used for dissolving and removing the organic resin component from the substrate. However, in the description, the peeling liquid is processed as a liquid in which the organic resin component peeled from the substrate is dissolved, that is, a liquid in which the organic resin component coated on the substrates of a predetermined number of sheets in the peeling process is dissolved. In addition, the “processing liquid” is a liquid in which the organic resin component is decomposed as the peeling liquid described later is subjected to the recycling process by ozone gas. Moreover, a “recycled liquid” is a liquid after the processing liquid is subjected to the ion exchange process by the ion exchange resin described later.

### (Process by Ozone Gas)

It is supposed that ozone gas generates a reaction with the organic resin component in the peeling liquid as represented by Formula (1) and generates products such as organic acid and low-molecular components by the decomposition of the organic resin component. In this example, assuming that phenol-based compounds can be obtained by dissolving and removing the resist, a decomposition behavior by ozone is exemplified, where stoichiometry is ignored.

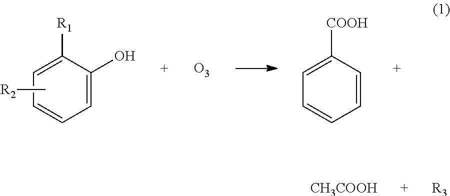

(R₁, R₂, and R₃ represent organic groups)

In the above example, the phenol-based compounds are decomposed into low-molecular compounds such as benzoate and acetate.

Techniques using ozone gas for the recycling process of the peeling liquid have been used until now. However, in a method of aerating oxygen gas in the liquid by an aeration method used at atmospheric pressure or a pressure close thereto, solubility to water or solvent is low and thus efficiency is low, and there are problems in that reactions take a long time and a processing agent is expensive. There, a method of allowing ozone gas with the same or higher pressure than that of the peeling liquid to contact the peeling liquid pressurized by a circulation pump in a mixer, or a method of allowing gas-liquid contact using a nonporous membrane module can be used. By the methods, the ozone gas is allowed to contact the peeling liquid as fine bubbles while maintaining the pressure of the ozone gas at a high pressure, thereby sufficiently decomposing the organic resin component.

The recycling process of the peeling liquid for dissolving and peeling the organic resin component on the substrate surface using the ozone gas may be performed after removing the peeling liquid into a different tank from that used for the peeling process or may be subsequently performed on the peeling liquid during the peeling process.

When the tank is used, shapes of the tank are not particularly limited, and, the tank may have a structure for sealing liquid and can be attached with an agitator for maintaining liquid in a uniform state. By sealing the liquid, the volatilization of solvent components is prevented and thus aggregation and precipitation of the dissolving organic resin component can be prevented. Simultaneously, the incorporation of water or dirt in the atmosphere can be prevented. In addition, as the liquid is always agitated by the agitator, nonuniformity of the liquid during the recycling process by the ozone gas or during storage can be prevented, thereby maintaining a uniform state.

In addition, in order to perform an ozone process subsequently in the peeling process, an in-line moisture meter or an in-line absorption spectrometer may be installed as a mechanism for monitoring the property and state of the peeling liquid all the time; however, they are not essential. Furthermore, a deaeration module can be installed in a circulation line of the ozone process to deaerate the ozone gas from the peeling liquid using pressure reduction or deaerate the ozone gas by blowing nitrogen gas or an inert gas into a deaeration tower so as to return the liquid to the peeling process.

The generation method of the ozone gas used according to the invention is not particularly limited, and the ozone gas may be generated by silent discharge or electrolysis. Particularly, an ozone generator in a silent discharge type using oxygen gas and nitrogen gas as raw materials can be used to generate ozone since high-concentration ozone gas can be simply and easily acquired. Though the concentration of the ozone gas is not particularly limited, higher concentration is more efficient as the recycling process can be implemented for a short time. According to the invention, a mixed gas of oxygen gas and nitrogen gas containing ozone with a concentration in the range of from 200 to 500 g/m³ can be used. More specifically, the ozone concentration can be in the range of from 300 to 450 g/m³.

As described above, as a reactor of the peeling liquid and the ozone gas, a reactor provided with a nonporous membrane module, a gas-liquid reactor, and an aeration tube in a tank may be used. Though the pressure of the peeling liquid and the ozone gas used therefore is not particularly limited, the pressure can be in the range of from 0.01 to 0.4 MPaG. More specifically, the pressure can be in the range of from 0.05 to 0.3 MPaG. In addition, the deaeration module may be installed in a circulation line of the peeling liquid to deaerate unreacted ozone gas.

In addition, a method using a filtration member installed for filtering the liquid during the ozone process in the circulation line of the processing liquid so as to remove solid substances with ozone resistance incorporated into the peeling liquid may be used. Accordingly, the residual solid substances that are not decomposed by the ozone process can be removed, thereby preventing the solid substrates from remaining in the processing liquid. In addition, a material of the filtration member is not particularly limited as long as the material is resistant to the peeling liquid. However, a filtration member made of fluororesin which is resistant to many organic solvents can be used, and more specifically, a filtration member made of a hydrophilic fluororesin can be used.

In addition, in order to prevent the excessive process by the ozone gas, the above-mentioned absorption spectrometer can be used to continuously measure absorbance of the processing liquid so that the process by the ozone gas can be performed until the organic resin component that absorbs a specific wavelength reaches an absorbance in a sufficiently decomposed state.

The processing liquid after being subjected to the recycling process by ozone may be allowed to contact the ion exchange resin as it is by switching a valve installed in the line or may be allowed to contact the ion exchange resin after deactivating ozone dissolving in the processing liquid by storing the processing liquid in another tank for a sufficient time. Though the shape of this other tank is not particularly limited, a tank provided with an exhaust port for exhaust gas and an agitator for maintaining the processing liquid in a uniform state can be used. Therefore, deaeration of the ozone gas can be accelerated by exhausting the gas while avoiding incorporation of water or dirt into the processing liquid. In addition, nonuniformity of the processing liquid in storage can be prevented by agitating the processing liquid with the agitator always, thereby maintaining the uniform state.

### (Process by Ion Exchange Resin)

Thereafter, the organic acid in the processing liquid is allowed to contact the ion exchange resin, and products such as the organic acid generated by the decomposition of the organic resin component are adsorbed onto the ion-exchange resin so as to be removed from the processing liquid by the reaction as expressed by the following Formula (2).

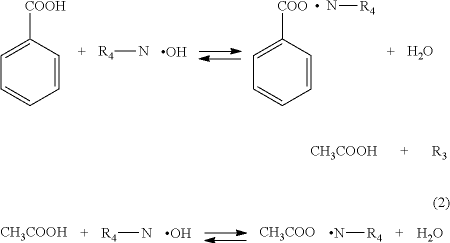

(R₄—N.OH is an anion exchange resin)

An ion exchange unit used in the method according to the invention is not particularly limited, and electric regeneration type ion exchange or polarity reversal type electric desalination using an ion exchange resin membrane, and a column type in which a granular ion exchange resin is filled in a column can be used. Particularly, the column type using the granular ion exchange resin is generally used. As the ion exchange resin, any of a mixed ion exchange resin, an anion exchange resin, and a cation exchange resin may be used. As the mixed ion exchange resin, for example, there is a styrene gel-type resin. As the anion exchange resin, for example, there is an acrylic gel-type resin. As the cation exchange resin, for example, there is an acrylic porous-type resin. They may be used singly, or two or more kinds of the ion exchange resins may be combined for use.

According to the invention, from the viewpoint that acid components generated by the ozone reaction as expressed by Formula (1) are to be removed, at least the anion exchange resin can be used. The anion exchange resin may be singly used, or the mixed ion exchange resin obtained by mixing the anion exchange resin with the cation exchange resin at an arbitrary proportion may be used. Otherwise, more preferably, in terms of an ion amount in the processing liquid, after the processing liquid is initially subjected to ion exchange by the anion exchange resin, the processing liquid can be subjected to ion exchange by the mixed ion exchange resin. In a case where cationic impurities such as metal ions are contained, the cation exchange resin can be used to remove them. In this process, when water exists in the peeling liquid, dissociation of H⁺ from a carboxyl group is accelerated to produce carboxylic anions, resulting in an increase in ion exchange efficiency.

According to the invention, in terms of enhancement of the ion exchange efficiency, water may be added to the additional peeling liquid after the process by the ozone gas and before the process by the ion exchange resin.

A basic structure of the ion exchange resin may be styrene or acrylic and may employ any of a gel type, a porous type, and a high-porous type, and the gel type can be used in terms of handling. In addition, the anion exchange resin may be strongly basic or weakly basic, and a functional group and an ion formation thereof are not particularly limited. Furthermore, the cation exchange resin may be strongly acidic or weakly acidic, and a functional group and an ion formation thereof are not particularly limited. In addition, the mixing proportion of the mixed ion exchange resin between the cation resin and the anion resin is not particularly limited, and may be suitably selected according to an embodiment for effectively performing the ion exchange.

According to the invention, as the ion exchange resin, an ion exchange resin of which an absorbance increment at a wavelength of the peeling liquid of 270 nm is equal to or greater than 1 times and equal to or smaller than 3 times before and after immersion when the ion exchange resin is immersed into the peeling liquid can be used. The ion exchange resin has resistance to the used peeling liquid and an elution amount of impurities is small when the processing liquid for performing the ion exchange is passed, thereby preventing accumulation of impurities. This is an effective way in terms of reduction in loads by preprocessing the ion exchange resin. More specifically, the absorbance increment can be equal to or greater than 1 time and equal to or smaller than 1.5 times.

The contact between the ion exchange resin and the processing liquid may be allowed by passing the processing liquid through the column filling the ion exchange resin, or by injecting the ion exchange resin into a storage tank in a batch type. When the batch type is employed, after removing the ion exchange resin from the processing liquid by an additional filtration member, a recycled liquid is returned to a resist peeling process. An end point of the ion exchange process may be determined by checking whether or not the recycled liquid is returned to a neutral range using a pH meter or a suitable method including titration, or checking whether or not an electrical conductance of the recycled liquid reaches a predetermined value.

In addition, the ion exchange resin used for the ion exchange may be disposed of after use to be replaced every time. However, in terms of running cost and environmental load, the ion exchange resin may be processed to be recycled so as to be repeatedly used. By performing an additional recycling process on the ion exchange resin into which the products are adsorbed after the decomposition of the organic acids, the ion exchange ability thereof is recovered. Accordingly, in the re-use, products produced by the decomposition by the ozone gas or impurities produced by the recycling process can be removed, thereby obtaining a recycled peeling liquid with a reduced concentration thereof in the liquid. When the resin component is decomposed by the ozone gas, a plurality of kinds of unspecified organic acids is produced. Since those are different in properties such as melting points, they cannot be effectively removed by distillation. According to the invention, such unspecified organic acids can be removed by the ion exchange process collectively, thereby effectively recycling the peeling liquid.

### (Recycling Device of Peeling Liquid)

An example of a recycling device of the peeling liquid according to the invention and a recycling method of the peeling liquid using the recycling device will be described, however, the invention is not limited thereto.

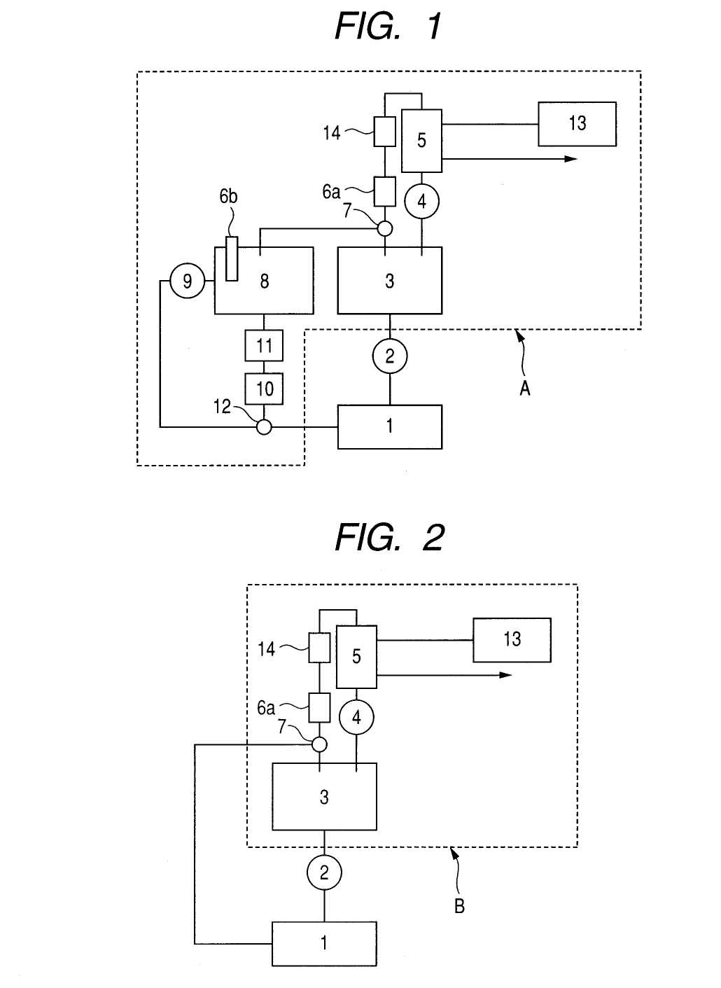

FIG. 1 illustrates an example of a substrate processing apparatus including the recycling device A of the peeling liquid according to the invention. The processing apparatus illustrated in FIG. 1 includes as a means for peeling the organic resin component from the substrate surface with the peeling liquid, a peeling tank 1 which is filled with the peeling liquid for immersing the substrate. The new peeling liquid is injected to the peeling tank 1 by mixing a water-soluble carbonyl compound with water with a mixing device (not illustrated) at a predetermined ratio. The recycling device A of the peeling liquid includes an ozone processing unit and an ion exchange unit. The ozone processing unit for processing the peeling liquid to decompose the organic resin component in the peeling liquid by using the ozone gas so as to be used as the processing liquid, includes a gas-liquid reactor 5 for allowing the peeling liquid to contact the ozone gas and an ozone generator 13 for generating ozone gas. In addition, the ion exchange unit for processing the processing liquid using the ion exchange resin to be used as the recycled liquid includes columns 10 and 11 which are filled with the ion exchange resin for performing the ion exchange process by passing the processing liquid therethrough. Hereinafter, the example of the substrate process using the substrate processing apparatus illustrated in FIG. 1 and the recycling method of the peeling liquid will be described.

First, the peeling liquid according to the invention is introduced into the peeling tank 1 illustrated in FIG. 1. The substrate having the organic resin component on the surface is immersed into the peeling liquid filling the peeling tank 1 and ultrasonic waves are applied as needed to dissolve and peel the organic resin component.

The total peeling liquid in which the organic resin component is dissolved and peeled is removed by a extract pump 2 from the peeling tank 1 to be collected into a storage tank 3. Thereafter, the peeling liquid is introduced to the gas-liquid reactor 5 by a circulation pump 4 connected to the storage tank 3. The peeling liquid discharged from the gas-liquid reactor 5 is returned to the storage tank 3 so as to be circulated.

After a pressure of the circulating peeling liquid at an outlet of the gas-liquid reactor 5 reaches a predetermined pressure, ozone gas is generated by the ozone generator 13, and the ozone gas is sent into the gas-liquid reactor 5 to be allowed to contact the peeling liquid, thereby performing the recycling process by the ozone gas. A deaeration module 14 is installed in a circulation line to deaerate unreacted ozone gas from the processing liquid so as not to allow the ozone gas to be sufficient in the storage tank. In addition, during the ozone gas process, absorbance is measured by a measurer 6a installed in the circulation line to measure absorbance so as to observe an end point of the ozone gas process.

After checking the end point of the ozone gas process, generation of the ozone gas is stopped. Thereafter, an automatic valve 7 installed in the circulation line is switched to send the processing liquid to a storage tank 8.

The processing liquid is circulated by a circulation and returning pump 9 to pass through the columns 10 and 11 filling the ion exchange resin to enable the ion exchange process. For example, the column 10 is filled with the anion exchange resin, and the column 11 is filled with the mixed ion exchange resin. Electrical conductance of the processing liquid is measured by an electrical conductance meter installed as a measurer 6b (detection unit) in the storage tank, and a time point at which a change amount is 0 is considered as the end point of the ion exchange process, thereby obtaining the recycled liquid.

In addition, a circulation unit of the substrate processing apparatus according to the invention is constructed with pumps and sending and circulating lines.

Thereafter, the next peeling liquid is removed by the extract pump 2 from the peeling tank 1, and an automatic valve 12 is switched to send the recycled liquid to the peeling tank 1 to be reused as the peeling liquid. The recycled liquid processed to be recycled as described above has the same peeling performance as the peeling liquid before being used to peel the organic resin component.

The recycled liquid may be reused directly as the peeling liquid. Otherwise, water or other components thereof may be re-adjusted so as to be used, or the recycled liquid may be mixed with a peeling liquid newly injected so as to be used.

### (Manufacturing Method of Substrate for Ink Jet Printer)

A manufacturing method of an ink jet printer substrate according to the invention is not particularly limited as long as the peeling liquid used for peeling the organic resin component on the substrate surface is recycled by the recycling method according to the invention and reused in this method. Here, the organic resin component is the resist mask that remains after the photolithography process performed using the resist mask.

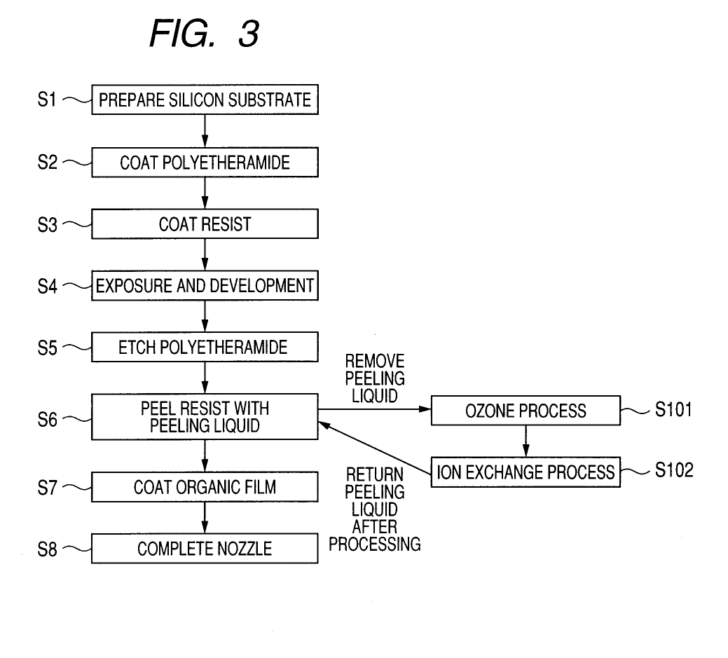

An example of the manufacturing method of the ink jet printer substrate according to the invention will be described with reference to FIG. 3. First, a silicon substrate constructed with a circuit for discharging ink is prepared (S1). Next, in order to increase adhesion between the substrate and the resin used for forming an ink discharge port and form a blocking layer for protecting the circuit from the ink, polyetheramide is coated by general spin coating or roll coating (S2). Further, in order to pattern the polyetheramide resin without photosensitivity using photolithography, a positive-type resist or a negative-type resist with photosensitivity is coated (S3). Using such resists as photomasks, pattern exposure and development are performed, and by etching the polyetheramide thereafter (S4), a desired pattern is obtained. Next, in order to remove the resist that had served as the etching mask, the silicon substrate is immersed into the peeling liquid to peel the entire resist on the substrate (S6). The ozone process is performed as described above on the peeling liquid in which the resist is dissolved (S101). Then the ion exchange process is performed on the peeling liquid after being subjected to the ozone process (S102). On the other hand, an organic film is coated on the silicon substrate to form the ink discharge port (S7), and the patterning is repeated using the photolithography, thereby forming a nozzle for discharging the ink on the substrate (S8). The processes S1 to S8 and the processes S101 and S102 may be sequentially performed or may be performed concurrently.

### EXAMPLES

Hereinafter, embodiments of the invention will be described with reference to the accompanying drawings. The invention is not limited by the examples described as follows without departing from the spirit and scope of the invention. Further, the terms “part”, “%”, “percent” in the description refer to mass standard where not particularly defined otherwise.

### <Evaluations>

### (Peeling Performance)

The silicon substrate was immersed into the recycled liquid, and a time from the starting of the peeling of the organic resin component until the compound is completely peeled was measured.

### (Evaluation on Silicon Substrate)

Thicknesses of an aluminum film on the substrate surface before and after the peeling of the organic resin component by the recycled liquid after 5,000 sheets were processed and recycled were measured. Evaluation references are shown as follows.

A: an amount of change in thickness is equal to or less than 0.02 μm

B: an amount of change in thickness is greater than 0.02 μm and equal to or smaller than 0.05 μm

C: an amount of change in thickness is greater than 0.05 μm

In addition, for each silicon substrate processed by the recycled liquid after 5,000 sheets were processed and recycled, chips arranged on the substrate surface were observed respectively using a metallurgical microscope, and when foreign matter or deformation was admitted, yield is calculated as inadequacy. Evaluation references are shown as follows.

A: yield is equal to or greater than 90%

B: yield is equal to or greater than 80% and smaller than 90%

C: yield is smaller than 80%

### (Evaluation on Ink Jet Printer Head)

An ink jet printer head was manufactured from the chips of each silicon substrate processed by the recycled liquid after 5,000 sheets were processed and recycled, and printed matter actually printed by a printer was observed with the naked eye. Evaluation References are shown as follows.

A: there is no fluctuation in the printed matter

B: there is one point of non-discharge or deflection

C: there are two or more points of non-discharge or deflection

### (Measurement of Absorbance Before and After of Immersion of Ion Exchange Resin)

20 parts of the ion exchange resin used in the invention were immersed into 100 parts of the peeling liquid, and absorbance of the peeling liquid at a wavelength of 270 nm before and after the immersion was measured by an absorption spectrometer “U-3310” (brand name, manufactured by Hitachi High-Technologies Corporation).

### Example 1

First, a peeling liquid (hereinafter, referred to as GBL 80) was prepared by mixing 20 parts of water with 80 parts of γ-butyrolactone (GBL) and is sufficiently agitated and mixed so as to be introduced into the peeling tank 1 illustrated in FIG. 1.

In addition, as the organic resin component to be peeled from the substrate surface, a novolac-based positive resist “OFPR-800” (brand name, manufactured by Tokyo Ohka Kogyo Co., Ltd.) was coated on the polyetheramide film of the silicon substrate by a spinner. Thereafter, after pre-baking, exposure was performed using a mask aligner, and development was then performed. Next, in order to remove the polyetheramide film at the lower layer, the silicon substrate was injected into an oxygen plasma asher and left in oxygen plasma for 12 minutes to ash the polyetheramide. Thereafter, the silicon substrate was immersed into the GBL80 filled in the peeling tank 1 at 25 degrees for 5 minutes, the residual resist was removed by applying ultrasonic waves, and this liquid was considered as the recycled peeling liquid. Moreover, as well as the polyetheramide film, the aluminum film existed on the silicon substrate surface.

After peeling a predetermined number of sheets, the entire amount of the peeling liquid was removed by the extract pump 2 from the peeling tank 1 so as to be collected into the storage tank 3 and was mixed by the agitator installed in the storage tank 3 to be uniform. Thereafter, the peeling liquid was introduced to the gas-liquid reactor 5 by the circulation pump 4 connected to the storage tank 3. The peeling liquid discharged from the gas-liquid reactor 5 was returned to the storage tank 3 to be circulated. Then, after the pressure of the circulating peeling liquid at the outlet of the gas-liquid reactor 5 reached 0.2 MPaG, ozone gas was generated by the ozone generator 13 “SGVP-440” (brand name, manufactured by Sumitomo Precision Products Co., Ltd.) to be sent into the gas-liquid reactor 5. The ozone gas was allowed to contact the peeling liquid to perform the recycling process by the ozone gas. Moreover, the deaeration module 14 is installed in the circulation line to deaerate the unreacted ozone gas from the processing liquid and so as not to allow the ozone gas to be filled in the storage tank 3. In addition, during the recycling process, transmitting light type concentration meters “ModelAF12 sensor” and “Model612 indicator” (brand name, manufactured by Wedgewood) are installed as the measurer 6 to measure absorbance at a wavelength of 400 nm.

Generation of the ozone gas was stopped at a time point when the absorbance at 400 nm measured by the operations is equal to or smaller than 0.5 Abs. Thereafter, the automatic valve 7 installed in the circulation line was switched to send the processing liquid to the storage tank 8 so that the peeling liquid was mixed to be uniform by the agitator installed in the storage tank 8.

In addition, as the ion exchange resin, a gel-type mixed ion exchange resin “amberite ESG-2” (brand name, manufactured by Organo Corporation) was used. In the measurement of the absorbance of the ion exchange resin, a peak was not shown at a wavelength of 270 nm after the immersion, and an increment in the absorbance before and after the immersion was 1.2 times.

The ion exchange resin was filled in the column 10 and circulated through the column by the circulation and returning pump 9 to perform the ion exchange process. Electrical conductance of the liquid was measured by the electrical conductance meter installed as the measurer 6 in the storage tank 8, a time point at which the change amount becomes 0 is referred to as the end point of the ion exchange process, and this liquid is used as the recycled liquid. Further, the in-line near-infrared liquid component concentration meter “RD-300” (brand name, manufactured by KURABO Industries Ltd.) was installed to measure an amount of water.

Thereafter, the next peeling liquid was removed from the peeling tank 1 by the extract pump 2, and the automatic valve 12 was switched to send the recycled liquid to the peeling tank 1 so as to be reused as the peeling liquid. The initial peeling liquid which was a new liquid of the “GBL80” and the peeling liquid which was the recycled liquid exhibited the same peeling performance.

### Example 2

The recycling process was performed by the same method as in Example 1 except that a liquid positive-type resist “PMER-AR900” (brand name, manufactured by Tokyo Ohka Kogyo Co., Ltd.) was used as the resist to be peeled from the substrate surface.

### Example 3

The recycling process was performed by the same method as in Example 1 except that the resist peeling was performed using a peeling liquid (GBL90) including 90 parts of γ-butyrolactone and 10 parts of water instead of the “GBL80”.

### Example 4

The recycling process was performed by the same method as in Example 1 except that the resist peeling was performed using a peeling liquid (GBL68) including 68 parts of γ-butyrolactone and 32 parts of water instead of the “GBL80”.

### Example 5

The recycling process was performed by the same method as in Example 1 except that a gel-type strongly basic anion exchange resin “amberite IRA402BLCI” (brand name, manufactured by Organo Corporation) was used as the ion exchange resin. Absorbance of the ion exchange resin before and after the immersion was measured. No peak at a wavelength of 270 nm was shown after the immersion, and an increment in the absorbance before and after the immersion was 3.0 times.

### Example 6

A gel-type weakly basic anion exchange resin “amberite IRA67” (brand name, manufactured by Organo Corporation) and a gel-type mixed ion exchange resin “amberite ESG-2” (brand name, manufactured by Organo Corporation) were filled in the columns 10 and 11, respectively, as the ion exchange resins. The recycling process was performed by the same method as in Example 1 except that circulation was performed by the circulation and returning pump 9 to sequentially pass through the anion exchange resin and the mixed ion exchange resin for the ion exchange process. Absorbance of the anion exchange resin was measured before and after the immersion. A peak was rarely shown at a wavelength of 270 nm after the immersion, and an increment in the absorbance before and after the immersion was 2.5 times. In addition, the absorbance of the mixed ion exchange resin before and after the immersion was measured. The peak was rarely shown at the wavelength of 270 nm after the immersion, and an increment in the absorbance before and after the immersion was 1.2 times.

### Example 7

The recycling process was performed by the same method as in Example 1 except that the resist peeling was performed by a peeling liquid (EC80) including 80 parts of ethylene carbonate and 20 parts of water instead of the “GBL80”.

### Comparative Example 1

The recycling process was performed by the same method as in Example 1 except that the ion exchange process was not performed by the ion exchange resin after performing the recycling process by ozone gas using the recycling device B without the columns 10 and 11 and the automatic valve 12 as illustrated in FIG. 2. When 500 sheets of silicon substrate were processed, a reduction in the aluminum film on the substrate was admitted.

### Example 8

The recycling process was performed by the same method as in Example 1 except that the register peeling was performed by a peeling liquid (GBL92) including 92 parts of γ-butyrolactone and 8 parts of water instead of the “GLB80”. Some points where the thickness of the polyetheramide film that is the lower layer of the resist is slightly reduced after the resist peeling were shown; however, this did not affect the manufacturing of the head.

### Example 9

The recycling process was performed in the same method as in Example 1 except that the resist peeling was performed by a peeling liquid (GBL65) including 65 parts of γ-butyrolactone and 35 parts of water instead of the “GBL80”. Since the resist was peeled from the substrate, the peeling time was short. However, there was a case where the resist existed as a solid state in the peeling liquid, so that a longer time was taken for the recycling process by the ozone gas as compared with examples 1 to 6.

### Example 10

The recycling process was performed in the same method as in Example 1 except that a high-porous type weakly basic anion exchange resin “DIAION WA-30” (brand name, manufactured by Mitsubishi Chemical Corporation) was used as the ion exchange resin. Absorbance of the ion exchange resin before and after the immersion was measured. A peak was shown at a wavelength of 270 nm after the immersion and the absorbance was increased by 10 times before and after the immersion. In addition, discoloration on the resin after the immersion was admitted. The recycling process was performed on the peeling liquid using the ion exchange resin. Until 500 sheets of the silicon substrates were processed, there was no problem. However, after processing 2500 sheets, residues on the substrate were admitted.

### Example 11

The recycling process was performed in the same method as in Example 1 except that a porous-type weakly basic anion exchange resin “amberite IRA96SB” (brand name, manufactured by Organo Corporation) was used as the ion exchange resin. Absorbance of the ion exchange resin before and after the immersion was measured. A peak was shown at a wavelength of 270 nm after the immersion, and the absorbance was increased by 3.5 times before and after the immersion. The recycling process of the peeling liquid was performed using the ion exchange resin. Processing 2,500 sheets of the silicon substrates presented no problem; however, in the processing of 5,000 sheets, residues on the substrate were admitted.

The results of various evaluations on the recycled liquids obtained in Examples 1 to 11 and Comparative Example 1 are shown in Table 1.

### (Table 1)

| | | | | | | | | | | | | | Comparative |
|---|---|---|---|---|---|---|---|---|---|---|---|---|---|
| | | Examples | | | | | | | | | | | Example |
| | | 1 | 2 | 3 | 4 | 5 | 6 | 7 | 8 | 9 | 10 | 11 | 1 |
| Peeling | γ-butyrolactone | 80 | 80 | 90 | 68 | 80 | 80 | — | 92 | 65 | 80 | 80 | 80 |
| Liquid | Ethylene | — | — | — | — | — | — | 80 | — | — | — | — | — |
| [Part] | Carbonate | | | | | | | | | | | | |
| | Water | 20 | 20 | 10 | 32 | 20 | 20 | 20 | 8 | 35 | 20 | 20 | 20 |

| | | | | | | | | | | | | |
|---|---|---|---|---|---|---|---|---|---|---|---|---|
| Resist | OFPR- | PMER- | OFPR- | OFPR- | OFPR- | OFPR- | OFPR- | OFPR- | OFPR- | OFPR- | OFPR- | OFPR-800 |
| | 800 | AR900 | 800 | 800 | 800 | 800 | 800 | 800 | 800 | 800 | 800 | |
| Ion Exchange Resin | ESG-2 | ESG-2 | ESG-2 | ESG-2 | IRA402 | (1)IRA | ESG-2 | ESG-2 | ESG-2 | WA30 | IRA96SB | — |
| | | | | | BLCI | 67 | | | | | | |
| | | | | | | (2)ESG-2 | | | | | | |
| Absorbance Increment | 1.2 | 1.2 | 1.2 | 1.2 | 3.0 | 2.5 | 1.2 | 1.2 | 1.2 | 10 | 3.5 | — |
| [Times] | | | | | | 1.2 | | | | | | |
| Peeling Start | 15 | 22 | 12 | 25 | 15 | 15 | 16 | 15 | 10 | 25 | 15 | 15 |
| [Second] | | | | | | | | | | | | |
| Peeling End [Second] | 60 | 110 | 45 | 120 | 60 | 60 | 90 | 60 | 45 | 90 | 60 | 60 |
| Thickness Change | A | A | A | A | A | A | A | B | A | A | A | C |
| Amount | | | | | | | | | | | | |
| Yield | A | A | A | A | A | A | A | B | A | B | B | C |
| Print | A | A | A | A | A | A | A | A | A | B | B | C |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-187699, filed Aug. 13, 2009, which is hereby incorporated by reference herein in its entirety.

What is claimed is:

1. A processing method of liquid comprising:
decomposing a resin in liquid by allowing ozone gas to contact the liquid containing a water-soluble carbonyl compound and the resin; and
removing organic acid generated by decomposing the resin in the decomposing from the liquid by performing on the liquid after being subjected to the decomposing an ion exchange process using an ion exchange resin,
wherein the liquid to which the ion exchange process is performed contains water.

2. The processing method according to claim 1, wherein the water-soluble carbonyl compound is at least one kind selected from γ-butyrolactone, ethylene carbonate, ethylene acetate, and glycerol acetate.

3. The processing method according to claim 1, wherein the ion exchange resin contains an anion exchange resin.

4. The processing method according to claim 1, wherein the water-soluble carbonyl compound is γ-butyrolactone.

5. The processing method according to claim 1, wherein in the removing, an ion exchange process using an anion exchange resin is performed first on the liquid, and then an ion exchange process using a mixed ion exchange resin is performed on the liquid.

6. The processing method according to claim 1, wherein in the decomposing, the liquid contains water.

7. The processing method according to claim 1, wherein, after the decomposing, water is added to the liquid to be subjected to the ion exchange process.

8. The processing method according to claim 1, wherein the liquid which the ozone gas is allowed to contact in the decomposing is obtained by using the liquid containing a water-soluble carbonyl compound as a solvent and removing the resin from a substrate provided with the resin.

9. The processing method according to claim 1, wherein the liquid which the ozone gas is allowed to contact in the decomposing is obtained by using the liquid containing a water-soluble carbonyl compound and water as a solvent and removing the resin from a substrate provided with the resin.

10. The processing method according to claim 1, wherein a resin is removed from a substrate provided with the resin using the liquid containing a water-soluble carbonyl compound that is obtained through the removing step.

11. The processing method according to claim 9, wherein the water-soluble carbonyl compound is γ-butyrolactone, and the liquid contains water at a proportion of equal to or greater than 10 mass % and equal to or smaller than 32 mass % with respect to mass of the liquid.
